(19) United States
(12) Patent Application Publication
(10) Pub. No.: US 2021/0295649 A1
(43) Pub. Date: Sep. 23, 2021

(54) Card Managing Device for a Gaming Machine

(71) Applicant: Top Vending Machine Electronics Co., Ltd., Taoyuan City 33868 (TW)

(72) Inventor: Yuan-Fong Chang, Taoyuan City (TW)

(21) Appl. No.: 16/822,325

(22) Filed: Mar. 18, 2020

(51) Int. Cl. G07F 17/32; G07F 7/02; G06K 19/07; G06F 1/18; G06F 1/16

(52) U.S. Cl. CPC G07F 17/3251; G07F 7/02; H04W 4/80; G06F 1/185; G06F 1/1601; G06K 19/0723

(57) ABSTRACT

A card managing device for a gaming machine includes a housing unit having front and rear housings. The front housing includes a surface having first and second hollow portions and a card slot. The front housing further includes a card passage defined between upper and lower stop plates extending rearwards from upper and lower sides of the card slot, respectively. A control device is mounted in the housing unit and includes a controller, a reader/writer, a sensor, a display, and an inputting device. The reader/writer includes a read/write circuit board disposed on the upper stop plate and a read/write head mounted to the read/write circuit board and aligned with the card passage. The sensor is located on an upper side of the upper stop plate distant from the lower stop plate. The display and the inputting device are exposed via the first and second hollow portions, respectively.

### BACKGROUND OF THE INVENTION

The present invention relates to a card managing device for a gaming machine and, more particularly, to a card managing device mounted on a gaming machine to reduce a credit value of a card before permission of playing the gaming machine.

A common payment method for a player playing a game of a gaming machine is insert coins or a bill into a coin receiver or a bill receiver on the gaming machine, so as to obtain permission to play the game. The player has to troublesomely prepare coins or bills acceptable by the coin receiver or the bill receiver of the gaming machine, and much more inconvenience is caused when a large quantity of coins or bills is required. Furthermore, a manager of the gaming machine has to periodically recycle the coins and the bills received by the gaming machine, which is laborious, is difficult to obtain the business information, and is, therefore, disadvantageous to monitoring and management of the whole amusement arcade. Improvement is, thus, required.

### BRIEF SUMMARY OF THE INVENTION

An objective of the present invention is to provide a card managing device mounted on a gaming machine permitting a user to use the gaming machine by reducing a credit value of a card, avoiding inconvenience in exchanging and inserting coins. Furthermore, a manager of the gaming machine can simply and immediately obtain the status information of the card.

Another objective of the present invention is to provide a card managing device including a reader/writer and a sensor, such that the card managing device is capable of sensing an induction card or a chip card, greatly increasing the utility of the card managing device.

A further objective of the present invention is to provide a card managing device including two positioning boards fixed in an opening resultant from removal of a coin receiver or a bill receiver originally mounted to a gaming machine, avoiding inconvenience in installation.

A card managing device for a gaming machine according to the present invention includes a housing unit and a control device. The housing unit includes a front housing and a rear housing coupled to the front housing. The front housing includes a surface having a first hollow portion, a second hollow portion, and a card slot. The front housing further includes an upper stop plate and a lower stop plate extending rearwards from an upper side and a lower side of the card slot towards the rear housing, respectively, defining a card passage between the upper stop plate and the lower stop plate. The control device is mounted in the housing unit and includes a controller, a reader/writer, a sensor, a display, and an inputting device. The reader/writer, the sensor, the display, and the inputting device are electrically connected to the controller. The reader/writer includes a read/write circuit board and a read/write head mounted to a bottom side of the read/write circuit board. The read/write circuit board is disposed on a distal end of the upper stop plate. The read/write head is aligned with the card passage. The sensor is located on an upper side of the upper stop plate distant from the lower stop plate. The display and the inputting device are exposed via the first hollow portion and the second hollow portion, respectively.

In an example, the controller includes a control circuit board securely fixed to a rear side of the front housing and extending vertically. The control circuit board includes a lower section having a slot. The upper stop plate and the lower stop plate extend through the slot into an interior of the rear housing.

In an example, the controller further includes a wireless communication device and a setup device disposed on the control circuit board. The wireless communication device is comprised of an antenna and an RFID integrated circuit.

In an example, the controller further includes a plurality of connectors disposed on the control circuit board. The rear housing includes a plurality of notches in two side thereof. The plurality of connectors is exposed via the plurality of notches of the rear housing.

In an example, the rear housing includes a bottom having a plurality of draining holes.

In an example, the front housing includes two positioning boards extending from upper and lower sides of the front housing, respectively. Each of the two positioning boards has a notch.

In an example, the housing unit further includes a supporter having a fixing portion and a supporting portion extending from a side of the fixing portion. The fixing portion is securely fixed to a lower side of the lower stop plate. The supporting portion is connected to a distal end of the lower stop plate.

In an example, the lower stop plate includes a first stop portion extending upwards from the distal end thereof, and the read/write circuit board includes a second stop portion extending downwards from a distal end thereof.

In an example, the distal end of the lower stop plate includes a plurality of inclined water guiding groove.

In an example, the front housing includes two coupling holes on left and right sides thereof, respectively. The rear housing includes two coupling members on left and right sides thereof. The two coupling members are coupled with the two coupling holes to secure the front housing and the rear housing together.

The present invention will become clearer in light of the following detailed description of illustrative embodiments of this invention described in connection with the drawings.

### DESCRIPTION OF THE DRAWINGS

FIG. 1 is a perspective view of a card managing device for a gaming machine of an embodiment according to the present invention.

FIG. 2 is another perspective view of the card managing device of FIG. 1.

FIG. 3 is an exploded, perspective view of the card managing device of FIG. 1.

FIG. 4 is an exploded, perspective view of a front housing and a control device of the card managing device of FIG. 1.

FIG. 5 is a cross sectional view of the card managing device of FIG. 1.

FIG. 6 is a perspective view of a control device of FIG. 4.

FIG. 7 is a reader/writer of the control device of the card managing device of FIG. 1.

FIG. 8 is a diagrammatic perspective view illustrating use of the card managing device of FIG. 1.

FIG. 9 is a cross sectional view of the card managing device of FIG. 1 with a card inserted into the card managing device.

### DETAILED DESCRIPTION OF THE INVENTION

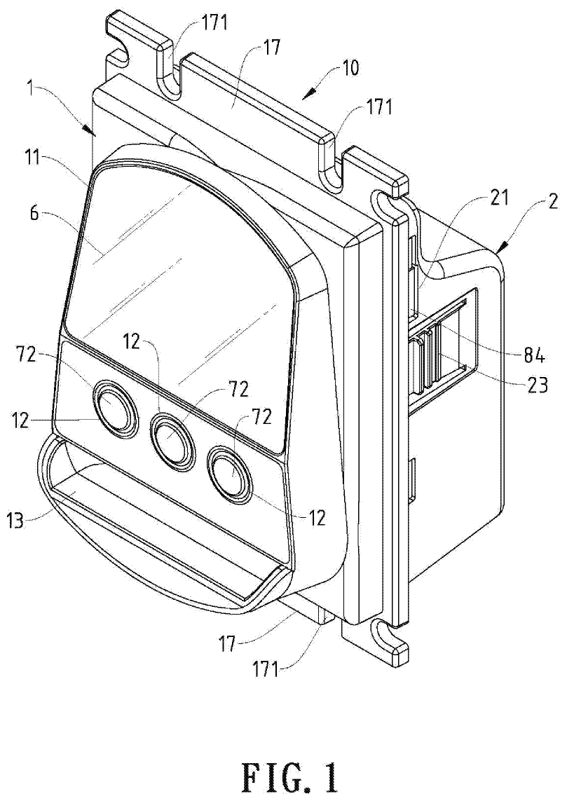

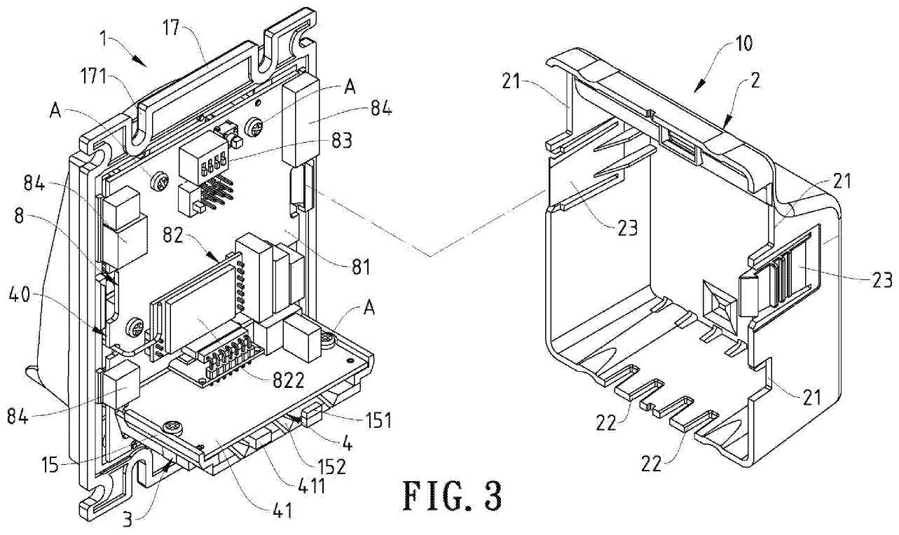

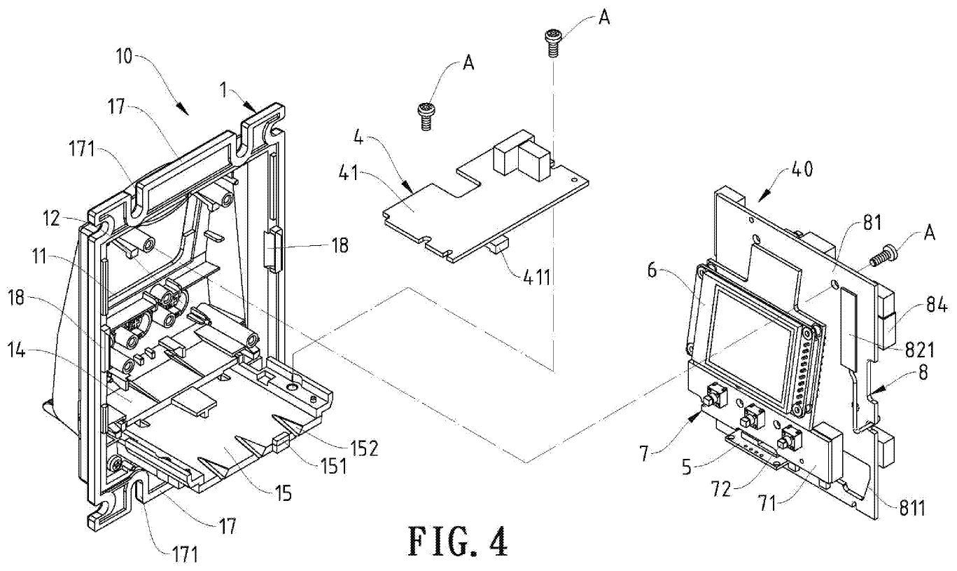

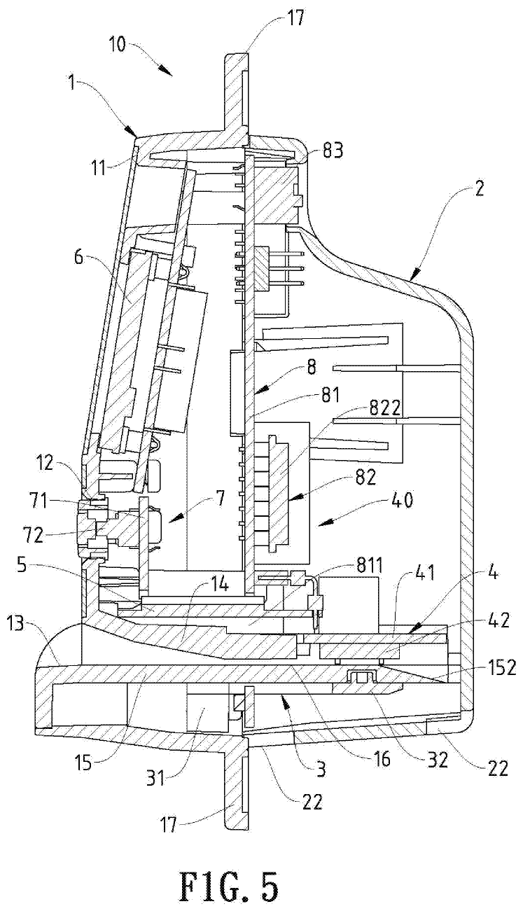

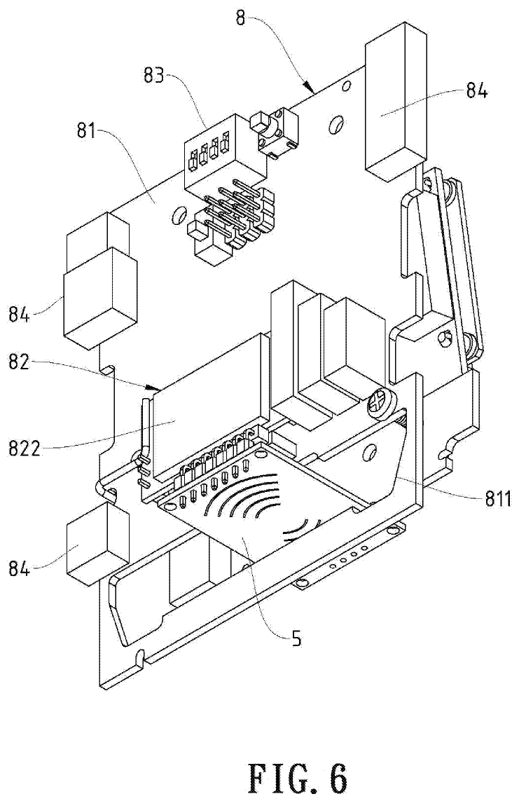

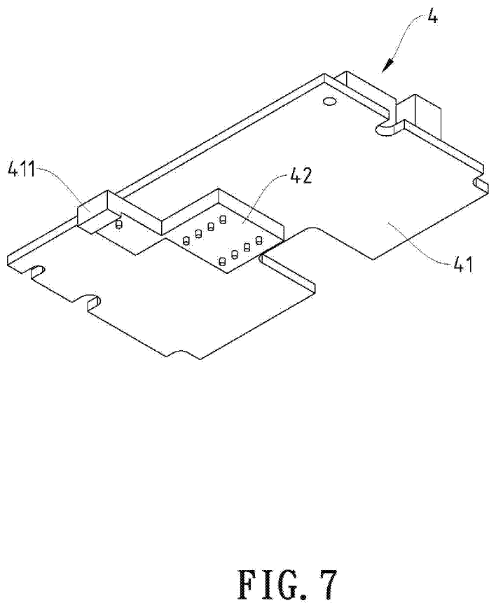

With reference to FIGS. 1-7, a card managing device for a gaming machine of an embodiment according to the present invention comprises a housing unit 10 and a control device 40. The housing unit 10 includes a front housing 1, a rear housing 2 coupled to the front housing 1, and a supporter 3. The front housing 1 includes a surface having a first hollow portion 11, a second hollow portion 12, and a card slot 13 below the second hollow portion 12. In this embodiment, the second hollow portion 12 has a plurality of holes. The front housing 1 further includes an upper stop plate 14 and a lower stop plate 15 extending rearwards from an upper side and a lower side of the card slot 13 towards the rear housing 2, respectively, defining a card passage 16 between the upper stop plate 14 and the lower stop plate 15. The lower stop plate 15 includes a first stop portion 151 extending upwards from a distal end thereof. The distal end of the lower stop plate 15 includes a plurality of inclined water guiding groove 152. The front housing 1 includes two positioning boards 17 extending from upper and lower sides of the front housing 1, respectively. Each of the two positioning boards 17 has a notch 171. The front housing 1 includes two coupling holes 18 on left and right sides thereof, respectively.

The rear housing 2 includes a plurality of notches 21 on left and right sides thereof. The rear housing 2 further includes two coupling members 23 on the left and right sides thereof. The two coupling members 23 are coupled with the two coupling holes 18 to secure the front housing 1 and the rear housing 2 together. The rear housing 2 further includes a bottom having a plurality of draining holes 22. The supporter 3 includes a fixing portion 31 and a supporting portion 32 extending from a side of the fixing portion 31. The fixing portion 31 is securely fixed to a lower side of the lower stop plate 15. The supporting portion 32 is connected to the distal end of the lower stop plate 15.

The control device 40 is mounted in the housing unit 10 and includes a controller 8, a reader/writer 4, a sensor 5, a display 6, and an inputting device 7. The reader/writer 4, the sensor 5, the display 6, and the inputting device 7 are electrically connected to the controller 8. The reader/writer 4 includes a read/write circuit board 41 and a read/write head 42 mounted to a bottom side of the read/write circuit board 41. The read/write circuit board 41 is disposed on a distal end of the upper stop plate 14 and is secured to the lower stop plate 15 by fasteners A, such that the read/write head 42 is aligned with the card passage 16. The read/write circuit board 41 includes a second stop portion 411 extending downwards from a distal end thereof. The sensor 5 is located on an upper side of the upper stop plate 14 distant from the lower stop plate 15 and is aligned with the card passage 16. The display 6 and the inputting device 7 are exposed via the first hollow portion 11 and the second hollow portion 12, respectively. The inputting device 7 includes an input circuit board 71 and a plurality of buttons 72 exposed via the plurality of openings of the second hollow portion 12.

The controller 8 includes a control circuit board 81, a wireless communication device 82, a setup device 83, and a connector 84. The control circuit board 81 is securely fixed to a rear side of the front housing 1 by fasteners A and extends vertically. The control circuit board 81 includes a lower section having a slot 811. The upper stop plate 14 and the lower stop plate 15 extend through the slot 811 into an interior of the rear housing 2. The wireless communication device 82 and the setup device 83 are disposed on the control circuit board 81. The wireless communication device 82 is comprised of an antenna 821 and an RFID (radio frequency identification) integrated circuit 822. The plurality of connectors 84 is exposed via the plurality of notches 21 of the rear housing 2.

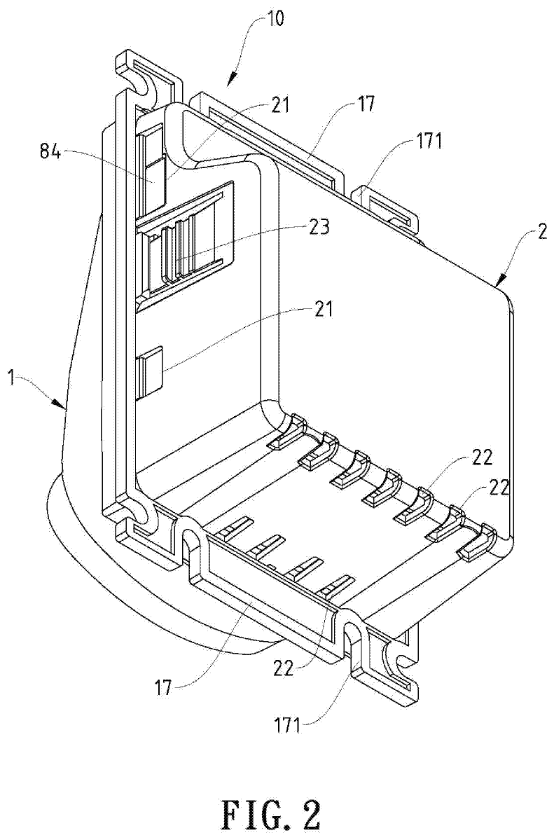

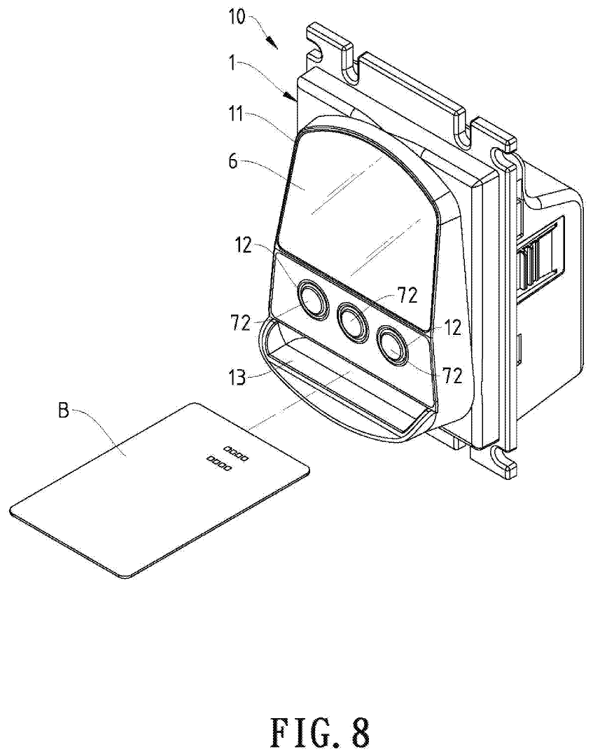

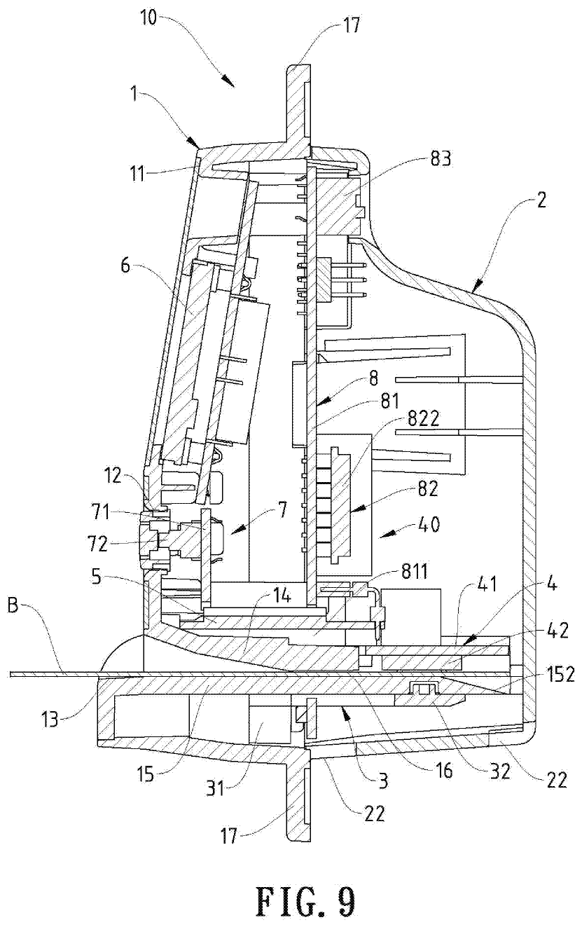

With reference to FIGS. 2, 4, and 6-9, in assembly, a coin receiver or a bill receiver of a gaming machine is removed, leaving an opening. Then, the two positioning boards 17 with the notches 171 are used to fix the housing unit 10 to the opening resulting from removal of the coin receiver or bill receiver. The plurality of connectors 84 is connected to the gaming machine, and the setup device 83 can be used to set up programs to be executed by the controller 8.

In use, a user can insert a stored-value card B through the card slot 13 into the card passage 16. The reader/writer 4 and the sensor 5 are aligned with different locations of the card passage 16. In a case that the stored-value card B is a chip card, the stored-value card B comes in contact with the read/write head 42 to proceed with reading/writing of the stored-value card B. In another case that the stored-value card B is an induction card, the sensor 5 proceeds with reading/writing of the stored-value card B, and the first stop portion 151 of the housing unit 10 and the second stop portion 411 of the control device 40 stop the stored-value card B to make sure the stored-value card B is in the desired position. After the stored-value card B is inserted into the card passage 16, the controller 8 displays the status (such as the balance) of the stored-value card B on the display 6 to inform the user. After the user knows the rules of playing the game by reducing the credit value of the stored-value card B, the gaming machine controls the controller 8 to reduce the credit value. Alternatively, the user can use the buttons 72 to reduce the credit value before playing the game. The wireless communication device 82 is wirelessly connected to a host computer (not shown) or the like, such that a manager or runner of the gaming machine can simply and rapidly know the status information of the stored-value card B.

During use, when a user unintentionally overturns a beverage container and the beverage flows into the card slot 13, the beverage will be drained via the card passage 16, the plurality of water guiding grooves 152, and the plurality of draining holes 22. When repair and maintenance are required, the coupling members 23 of the rear housing 2 are disengaged from the coupling holes 18 of the front housing 1, and the rear housing 2 is detached from the front housing 1 to expose the controller 8 for repair and maintenance.

Although specific embodiments have been illustrated and described, numerous modifications and variations are still possible without departing from the scope of the invention. The scope of the invention is limited by the accompanying claims.

1. A card managing device for a gaming machine, comprising:
a housing unit including a front housing and a rear housing coupled to the front housing, wherein the front housing includes a surface having a first hollow portion, a second hollow portion, and a card slot, and wherein the front housing further includes an upper stop plate and a lower stop plate extending rearwards from an upper side and a lower side of the card slot towards the rear housing, respectively, defining a card passage between the upper stop plate and the lower stop plate; and
a control device mounted in the housing unit, wherein the control device includes a controller, a reader/writer, a sensor, a display, and an inputting device, wherein the reader/writer, the sensor, the display, and the inputting device are electrically connected to the controller, wherein the reader/writer includes a read/write circuit board and a read/write head mounted to a bottom side of the read/write circuit board, wherein the read/write circuit board is disposed on a distal end of the upper stop plate, wherein the read/write head is aligned with the card passage, wherein the sensor is located on an upper side of the upper stop plate distant from the lower stop plate, and wherein the display and the inputting device are exposed via the first hollow portion and the second hollow portion, respectively.

2. The card managing device for the gaming machine as claimed in claim 1, wherein the controller includes a control circuit board securely fixed to a rear side of the front housing and extending vertically, wherein the control circuit board includes a lower section having a slot, and wherein the upper stop plate and the lower stop plate extend through the slot into an interior of the rear housing.

3. The card managing device for the gaming machine as claimed in claim 2, wherein the controller further includes a wireless communication device and a setup device disposed on the control circuit board, and wherein the wireless communication device is comprised of an antenna and an RFID integrated circuit.

4. The card managing device for the gaming machine as claimed in claim 2, wherein the controller further includes a plurality of connectors disposed on the control circuit board, wherein the rear housing includes a plurality of notches in two side thereof, and wherein the plurality of connectors is exposed via the plurality of notches of the rear housing.

5. The card managing device for the gaming machine as claimed in claim 1, wherein the rear housing includes a bottom having a plurality of draining holes.

6. The card managing device for the gaming machine as claimed in claim 1, wherein the front housing includes two positioning boards extending from upper and lower sides of the front housing, respectively, and wherein each of the two positioning boards has a notch.

7. The card managing device for the gaming machine as claimed in claim 1, wherein the housing unit further includes a supporter having a fixing portion and a supporting portion extending from a side of the fixing portion, wherein the fixing portion is securely fixed to a lower side of the lower stop plate, and wherein the supporting portion is connected to a distal end of the lower stop plate.

8. The card managing device for the gaming machine as claimed in claim 1, wherein the lower stop plate includes a first stop portion extending upwards from a distal end thereof, and wherein the read/write circuit board includes a second stop portion extending downwards from a distal end thereof.

9. The card managing device for the gaming machine as claimed in claim 1, wherein the lower stop plate includes a distal end having a plurality of inclined water guiding groove.

10. The card managing device for the gaming machine as claimed in claim 1, wherein the front housing includes two coupling holes on left and right sides thereof, respectively, wherein the rear housing includes two coupling members on left and right sides thereof, and wherein the two coupling members are coupled with the two coupling holes to secure the front housing and the rear housing together.
